(19) United States
(12) Patent Application Publication
(10) Pub. No.: US 2025/0262121 A1
(43) Pub. Date: Aug. 21, 2025

(54) TEMPERATURE CONTRAST THERAPY CHAMBER

(71) Applicant: Matthew Francis Elliott, Avon, OH (US)

(72) Inventor: Matthew Francis Elliott, Avon, OH (US)

(21) Appl. No.: 18/442,666

(22) Filed: Feb. 15, 2024

(51) Int. Cl. A61H 33/06; A61H 33/00

(52) U.S. Cl. CPC A61H 33/066; A61H 33/0087; A61H 2033/061; A61H 2201/0207; A61H 2201/0214; A61H 2201/0242; A61H 2201/5038

(57) ABSTRACT

Provided is a temperature therapy chamber comprising a housing with an interior for accommodating a user. The interior of the chamber has a heating system configured to increase the temperature within the housing to create a heated area. The housing also has a plunge pool system having a pool with an opening accessible from within the interior and configured to hold water and accommodate the user. A chiller is configured to decrease the temperature of the water in the pool. The user can move between the heated area and the pool without leaving the interior of the housing. The housing can also include a vertical rail system with a mounting plate slidably coupled to at least one rail on a wall of the housing and configured to removably support the heating element. The user can move the heating system between a top and bottom position of the vertical rail system.

### TECHNICAL FIELD

In general, the present invention relates to a temperature therapy chamber, and in particular to a sauna chamber that is combined with a cold plunge pool or tub.

### BACKGROUND OF THE INVENTION

Saunas have long been recognized as therapeutic spaces, offering relaxation and various health benefits through the application of heat. Originating from traditional Finnish practices, saunas have evolved over centuries, becoming integral components of wellness routines globally. Saunas are rooms or chambers with a stove or oven that provide intense heat. Users sit in the sauna room or chamber to experience hot temperature therapy. Traditional saunas typically rely on heated rocks, creating a high temperature environment. The hot temperature of the sauna may cause vasodilation of the user's blood vessels and promote blood flow and circulation in a user, amongst other health and recovery benefits.

Cold pools, recognized for their invigorating effects on the body, have been integral to hydrotherapy practices and wellness facilities. Immersion in cold water is known to stimulate circulation, reduce muscle inflammation, and contribute to overall well-being. Cold plunge tubs or pools are containers that hold water that is chilled either manually with ice or with water circulation and cooling systems. Users can submerge their bodies in the chilled water to experience cold temperature therapy. The cold temperature of the pools may cause vasoconstriction of the user's blood vessels and reduce inflation, amongst other health and recovery benefits.

Temperature contrast therapy, which combines hot temperature therapy methods and cold temperature therapy methods, has been recognized as a holistic approach to wellness. It offers an invigorating experience for individuals seeking relaxation, recovery, and rejuvenation. Generally, a user will spend time in hot temperature therapy, like a sauna, exit the hot therapy space, and then enter the cold therapy space. For instance, a user could spend ten minutes in a sauna, exit the sauna, and submerge themselves in a cold plunge pool or tub for three minutes. The user could do this same routine iteratively and for various time intervals. While each therapy provides unique benefits, the combination of these contrasting therapies can elevate the overall therapeutic experience. Temperature contrast therapy may provide a variety of health and recovery benefits. For instance, temperature contrast therapy may lead to improved circulation, muscle recovery, detoxification, endorphin release, stress reduction, skin health, immune system support, amongst other things.

### SUMMARY OF THE INVENTION

In accordance with an embodiment of the present application, a temperature therapy chamber comprises a housing with an interior for accommodating a user. The housing may have a heating system configured to increase the temperature within the housing to create a heated area in the interior. Additionally, the interior of the housing may have a plunge pool system. The plunge pool includes a pool having an opening accessible from within the interior of the housing and configured to hold water and accommodate the user. The plunge pool system may also include a chiller configured to decrease the temperature of the water in the pool. Because the heated area created by the heating system and the plunge pool system are both located within the interior of the housing, the user can move between the heated area and the pool without leaving the interior of the housing.

The temperature therapy chamber may also include a vertical rail system. This vertical rail system may have least one rail mounted to the wall of the housing that extends up the wall of the housing. A mounting plate may have a first side that is slidably coupled to the at least one rail and a second side that is configured to selectively couple to the heating element in the housing. The vertical rail system may also include a locking mechanism having a locked position and an unlocked position. The mounting plate can slide up and down the at least one rail to change the height of the heating element within the interior of the housing. In the locked position, the locking mechanism locks the position of the mounting plate relative to the at least one rail.

These and other objects of this application will be evident when viewed in light of the drawings, detailed description and appended claims.

### BRIEF DESCRIPTION OF THE DRAWINGS

FIG. 1 is a perspective view of an exemplary temperature contrast therapy chamber.

FIG. 2 is a front view of the exemplary temperature contrast therapy chamber.

FIG. 3 is a rear view of the exemplary temperature contrast therapy chamber.

FIG. 4 is a view of the second side of the exemplary temperature contrast therapy chamber.

FIG. 5 is a bottom view of the exemplary temperature contrast therapy chamber.

FIG. 6 is a perspective view of the exemplary temperature contrast therapy chamber with the front wall, the first side wall, and the roof removed.

FIG. 7 is a top view of the exemplary temperature contrast therapy chamber with the front wall, the first side wall, and the roof removed.

FIG. 8 is a first side perspective view of the exemplary temperature contrast therapy chamber with the first side wall and the roof removed.

FIG. 9A is a perspective view of the exemplary temperature contrast therapy chamber with the front wall, the first side wall, the roof, and the stairs removed and showing the heating system in the bottom position on the vertical rail system.

FIG. 9B is a front view of an exemplary temperature contrast therapy chamber with the front wall, the first side wall, the roof, and the stairs removed and showing the heating system in the bottom position on the vertical rail system.

FIG. 10A is a perspective view of an exemplary temperature contrast therapy chamber with the front wall, the first side wall, the roof, and the stairs removed and showing the heating system in a top position on the vertical rail system.

FIG. 10B is a front view of an exemplary temperature contrast therapy chamber with the front wall, the first side wall, the roof, and the stairs removed and showing the heating system in a top position on the vertical rail system.

FIG. 11A is a front view of an exemplary vertical rail system.

FIG. 11B is a perspective view of the exemplary vertical rail system with the mounting plate in the bottom position.

FIG. 11C is a perspective view of the exemplary vertical rail system with the mounting plate in the top position.

FIG. 12A is a perspective view of an exemplary temperature contrast therapy chamber with the front wall, the first side wall, the roof, and the stairs removed and showing cover in the closed position.

FIG. 12B is a perspective view of an exemplary temperature contrast therapy chamber with the front wall, the first side wall, the roof, and the stairs removed and showing cover in the closed position.

### DETAILED DESCRIPTION

Embodiments of the application relate to methods and systems for a temperature contrast therapy chamber. The temperature contrast therapy chamber integrates hot and cold elements within a single chamber so the user does not have to repetitively move in and out of and between their hot and cold therapy spaces. The temperature contrast therapy chamber includes distinct temperature zones that the user can transition between without having to leave the chamber. Like a sauna, the chamber creates high temperatures with a stove, oven, or other heating system. The stove or oven can be movable on a set of rails to provide a customizable hot temperature zone. To provide cold therapy, the chamber includes a cold plunge pool in the floor of the chamber. The water in the cold plunge pool can be cooled with a water chiller and water circulation system. To improve the efficiency of temperature contrast therapy chamber, the waste heat produced by the water chiller and circulation system can be recycled as an additional heating source for the chamber. Evaporation of the water in the cold plunge pool can be minimized with insulation. The temperature contrast therapy chamber can provide a streamline, integrated, and efficient system that provides a customizable temperature contrast therapy experience without having to exit the chamber.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

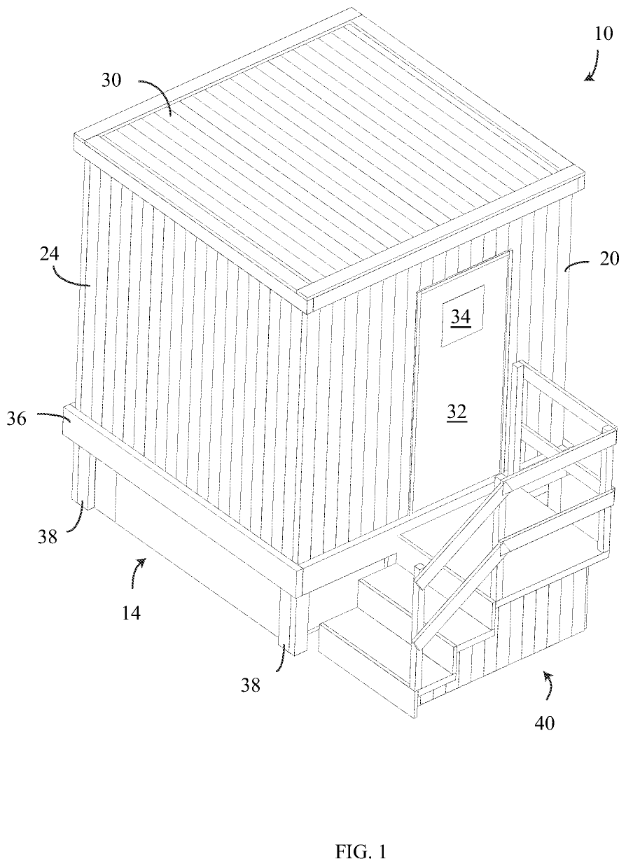

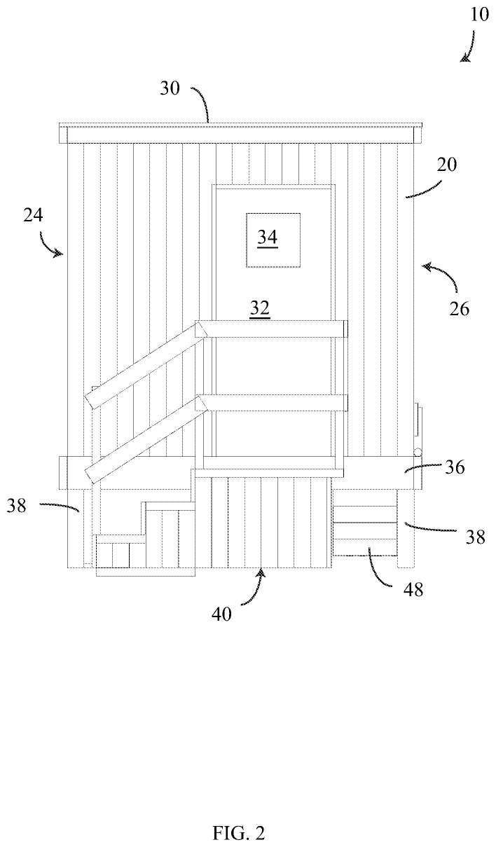

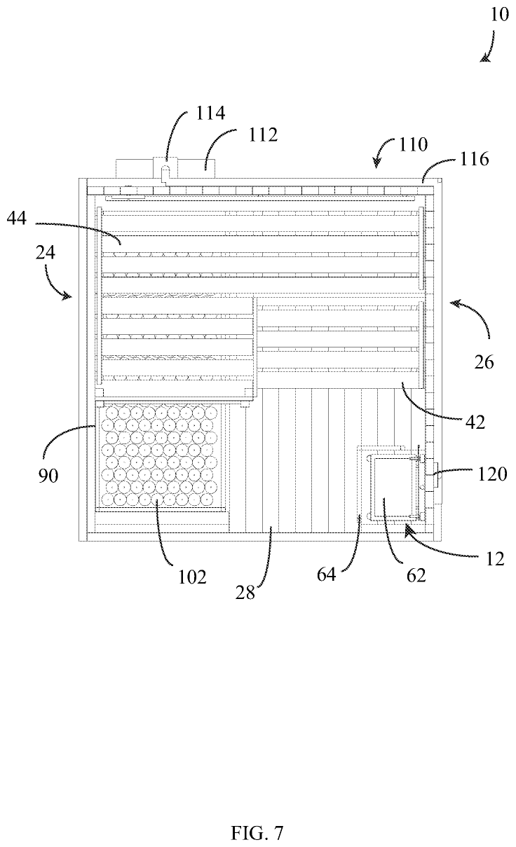

Turning now to FIGS. 1-8, a therapy chamber is shown generally at reference number 10. The therapy chamber 10 includes a heating system 12 and a plunge pool system 14. For illustrative and descriptive purposes, the therapy chamber 10 is a square or rectangular housing and is sized to effectively include the heating system 12 and the plunge pool system 14. It will be appreciated that the therapy chamber housing could be circular, cylindrical, pyramidal, polyhedral, or some other suitable shape. For instance, the therapy chamber could be shaped as a hexagonal prism. Additionally, it will be appreciated that the therapy chamber can vary in size. For instance, the therapy chamber 10 can be sized to accommodate multiple heating systems and a larger plunge pool, to allow for a larger number of users to participate in temperature contrast therapy. As illustrated, the therapy chamber 10 is substantially cube-shaped and has a front wall 20 and a back wall 22 opposite the front wall 20 and connected to the front wall 20 by a first side wall 24 and a second side wall 26. The therapy chamber 10 has a floor 28 that extends between the bottoms of the front wall 20, the back wall 22, the first side wall 24, and the second side wall 26. The therapy chamber 10 can have a roof 30 that extends between and covers the tops of the front wall 20, the back wall 22, the first side wall 24, and the second side wall 26. The front wall 20 includes a door 32 to enter and exit the chamber 10. As illustrated in FIGS. 1 and 2, the door 32 may have a window 34 to provide a view into the chamber 10 from outside of the chamber.

The heating system 12 is located within the walls of the chamber 10 to provide heat to the chamber 10. The plunge pool system 14 is located within the walls of the chamber 10 and can be integrated into the floor 28 of the chamber 10 so that a user can lower themselves into the plunge pool for cold therapy. To provide space for the plunge pool system 14 to be integrated into the floor 28, the therapy chamber 10 can be constructed on a platform 36. The platform 36 may be elevated and supported by a plurality of support legs 38. Stairs 40 can be included with the elevated platform 36 to provide access to the door 32. As illustrated, the stairs can include a railing. In an alternative embodiment, the platform 36 can be supported by the ground, and an area of the ground may be dug out to accept the plunge pool system 14 to allow the plunge pool system 14 remain level with the floor 28 in the chamber 10.

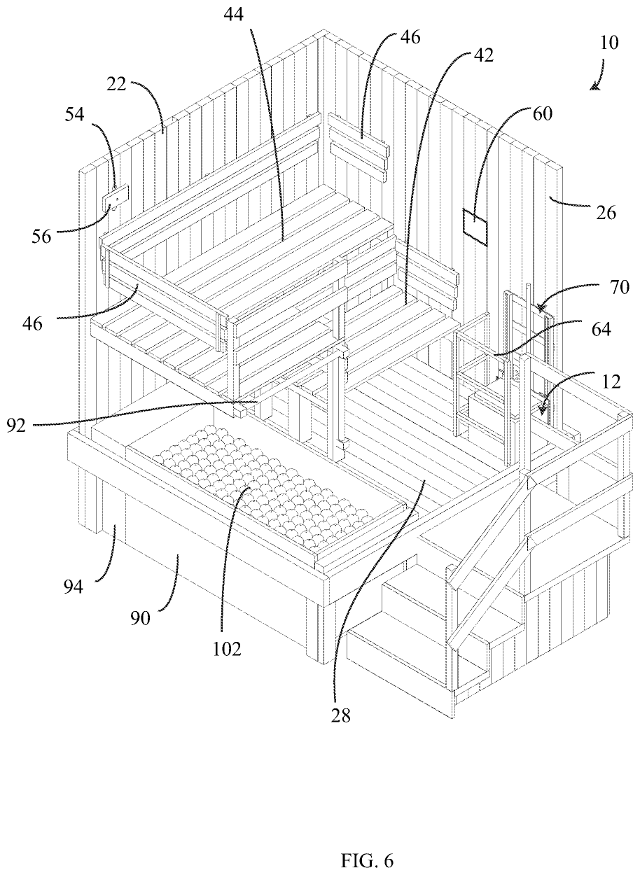

Turning to FIGS. 6-10B, the inside of the chamber 10 is illustrated. The chamber 10 includes at least one bench that a user may rest on, by sitting or lying down. Generally, heat rises in the chamber, so a user can experience more intense heat the higher they are sitting in the chamber 10. The chamber may have a first bench 42 supported by the floor 28 and the walls of the chamber 10 and a second bench 44 built on top of the first bench 42 and also supported by walls of the chamber 10. A plurality of railings 46 can extend around the exterior of the first bench 42 and the second bench 44 and on the walls of the chamber. The railings 46 can act as a safety rail for instance to prevent a user from falling off the second bench 44 into the plunge pool system 14. Additionally, the railings 46 can be used as a rest surface so users do not need to rest against the walls of the chamber 10. It will be appreciated that additional benches and railings can be used within the chamber 10 or that the benches and railings may be modular and movable and can be configured differently within the chamber 10. The therapy chamber 10, first and second benches 42 and 44, the railings 46, and other structural elements can be made from durable materials with a low heat conductivity. For instance, the chamber can be constructed with woods, like red or white cedar, spruce, redwood, hemlock, poplar, basswood, aspen, eucalyptus, fir, or another suitable soft wood. Alternatively, other materials can be used, such as glass, fiberglass, composites, or polymers.

The floor 28 of the chamber 10 may include an opening 47 to a housing 48 that extends downward from the floor 28 and is configured to receive the heating system 12 as will be further described below. The housing 48 is sized and shaped to provide proper space around the heating system 12 to allow airflow around the heating system 12 to minimize the potential of overheating. The housing 48 has a bottom surface 50 that extends between the walls of the housing 48 and closes the end of the housing 48 that extends below the floor 28. When the heating system 12 is lowered into the housing 48, cooling of the heating system 12 can be improved by improved airflow, and by removing at least a portion of the heating system 12 from the hotter environment in the chamber 10. For instance, industry and regulatory mandated high-temperature sensors in the heating system 12 could be placed in the cooler environment of the housing and operate at a lower temperature.

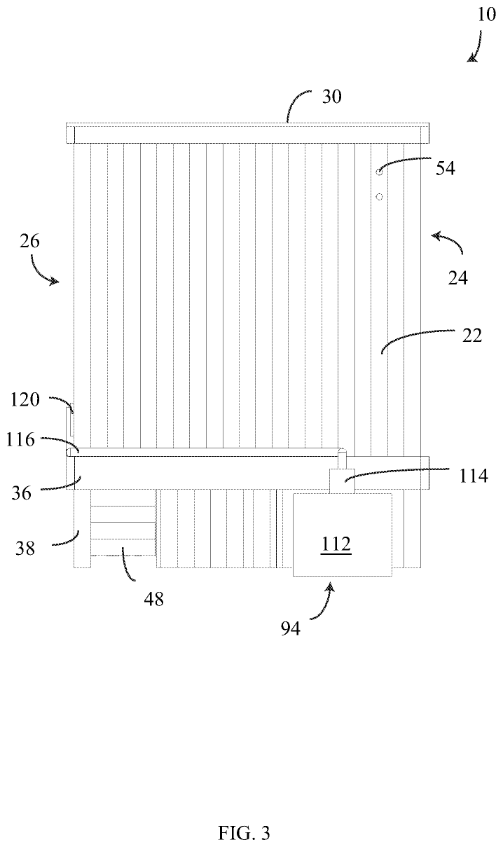

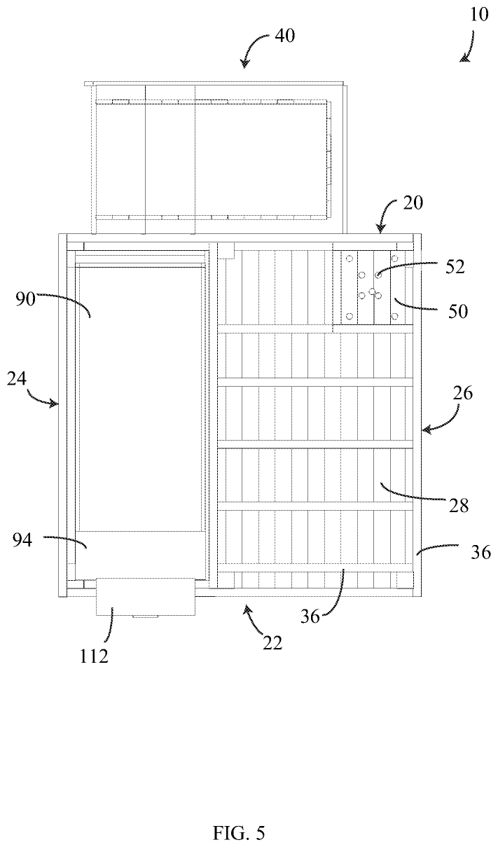

To promote airflow through the chamber 10, the chamber 10 may include ventilation inlet holes 52 and ventilation outlet holes 54. Airflow through the chamber 10 can be promoted by hot air rising through the chamber naturally. The ventilation inlet holes 52 can be located near the bottom of the chamber 10. For instance, as illustrated in FIG. 5, a plurality of ventilation inlet holes 52 can be located in the bottom surface 50 of the housing 48. Alternatively, the ventilation inlet holes 52 can be located near the bottom or middle of the front wall 20, back wall 22, first side wall 24, or second side wall 26. For instance, the ventilation inlet holes can be placed in the middle of the wall above the heating system 12. The ventilation outlet holes 54 can be located near the top or bottom of the front wall 20, back wall 22, first side wall 24, or second side wall 26 close to the roof 30, as illustrated in FIGS. 3 and 6, or close to the floor 28. Generally, air will enter through the ventilation inlet holes 52 in the bottom of the housing 48. The air will be heated by the heating system 12 and rise into the chamber 10. The air can flow out of the chamber 10 through the air ventilation outlet holes 54. An airflow restrictor 56 can be connected to the wall near the air ventilation outlet holes 54. The airflow restrictor 56 can be rotated over the air ventilation outlet holes 54 to partially cover and therefore partially restrict the airflow out of the chamber 10. Alternatively, the airflow restrictor can slide over the air ventilation outlet holes 54 to restrict the airflow. In an alternative embodiment, airflow could be forced through the chamber by fans. For instance, a fan can pull air into the chamber 10 at the ventilation inlet holes 52 or blow air out of the chamber 10 through the air ventilation outlet holes 54. A controller 60 in the chamber 10 can control the fans.

To heat the air in the chamber 10, the heating system 12 has a heating unit 62. The heating unit 62 may be an electric heater. Alternatively, the heating unit 62 may be a wood-fired stove, an infrared heater, a gas-burning heater, or some other suitable heat source. A controller 60 can be configured to control the heating unit 62. As illustrated in FIG. 6, the controller 60 can be placed on one of the walls of the chamber 10. The controller 60 can be used to control the heating system 12 in the chamber 10, as well as other systems within the chamber 10, as will be described in further detail below. The heating system 12 can also include safety features like temperature sensors to prevent the heating unit 62 from overheating. The temperature sensors and other safety features can be configured to communicate with the controller 60. A safety rail 64 can be placed around the heating system 12 to prevent a user from accessing the sides of the heating system 12. The safety rail 64 can be made from the same durable material as the rest of the chamber 10.

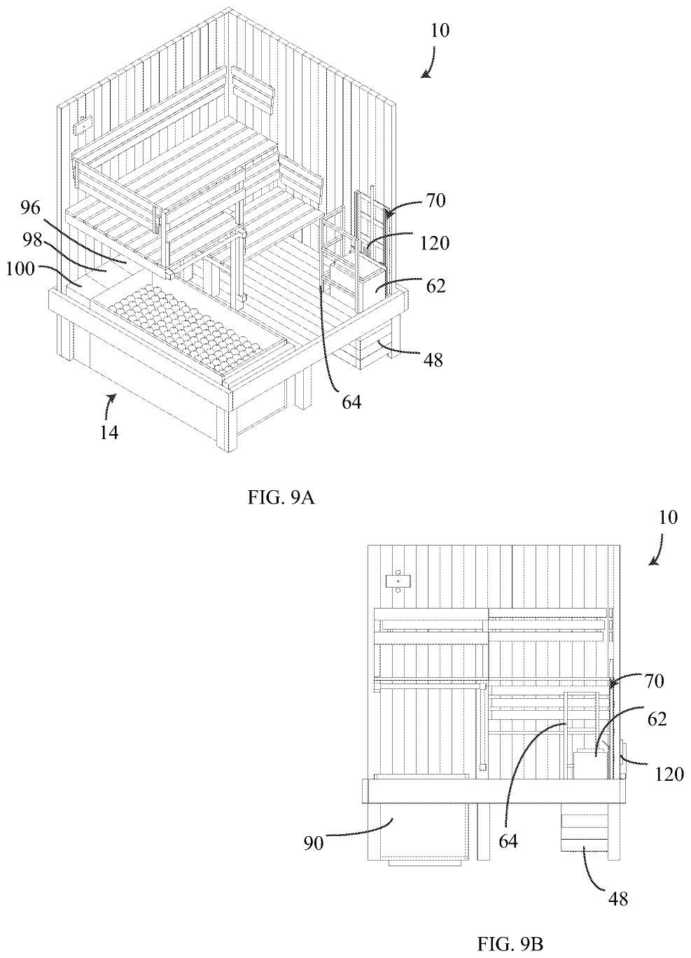

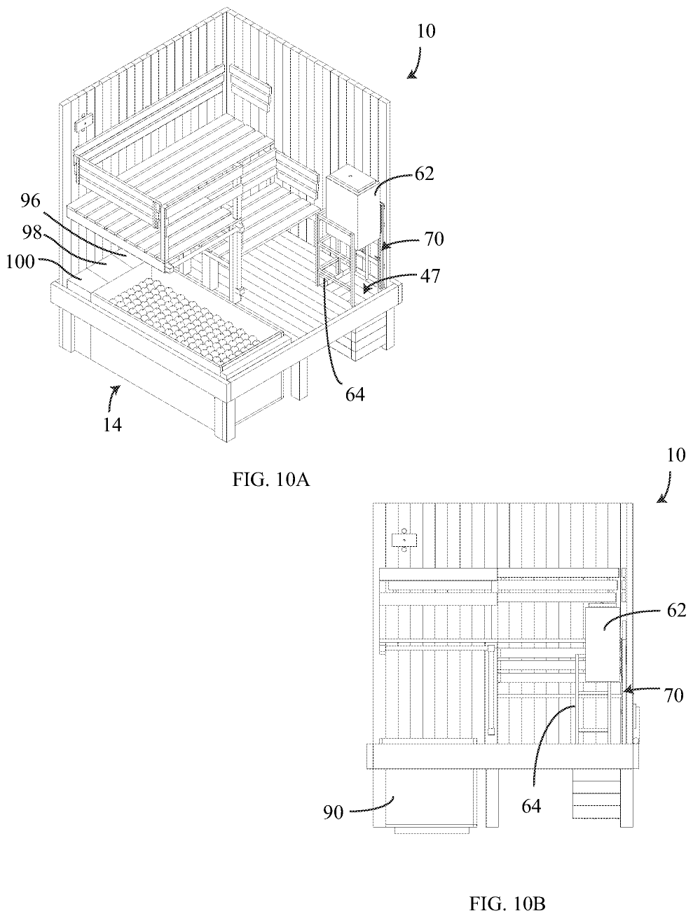

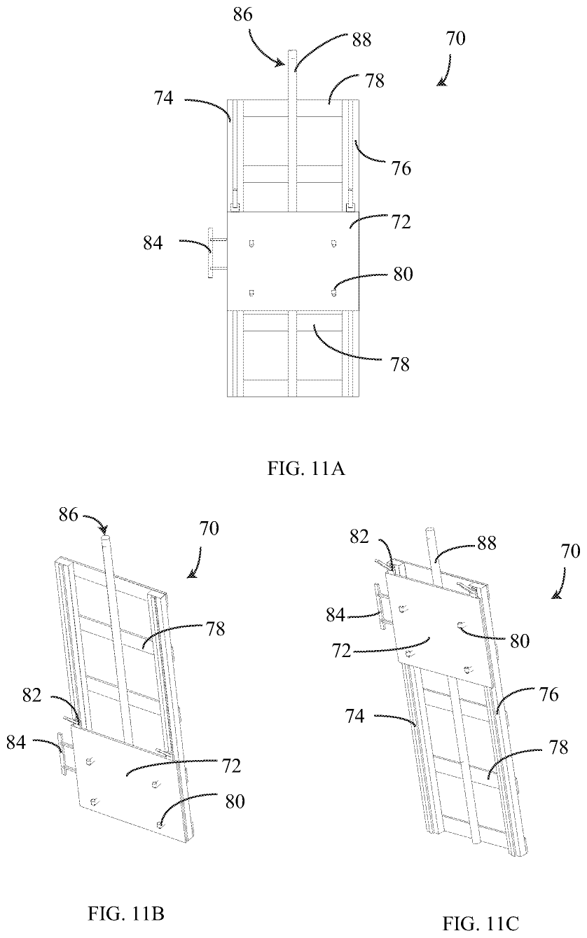

Turning to FIGS. 6-11C, to provide customizable heat distribution within the chamber 10, the heating system 12 can include a vertical rail system 70. The vertical rail system 70 includes a mounting plate 72 with a first side that is slidably mounted on a first rail 74 and a second rail 76. The first and second rails 74 and 76 can be installed on one of the walls of the chamber 10 with a plurality of horizontal mounting brackets 78 that are bolted to the wall. The first and second rails 74 and 76 can extend up a substantial portion of the wall. The heating unit 62 can be attached to a second side of the mounting plate 72 with a plurality of hooks 80 that extend outward from the mounting plate 72, as illustrated in FIGS. 11A-11C. The hooks 80 can engage holes or loops on the heating unit 62. Alternatively, the heating unit 62 can be connected to the mounting plate 72 with nuts and bolts, screws, pins, rivets, or some other suitable mechanical fasteners. The vertical rail system 70 allows the heating unit 62 to be placed at various heights within the chamber 10 by moving the mounting plate 72 up and down the first and second rail 74 and 76. The vertical rail system 70 allows the mounting plate 72 to be moved to a top position, a bottom position, or any position in between the top position and the bottom position. For instance, as illustrated in FIGS. 9A, 9B, and 11B, the mounting plate 72 and the heating unit 62 can be placed the bottom position. When in the bottom position, the heating unit 62 is located in the housing 48 in the floor 28. The heating unit 62 can also be moved to its top position, as illustrated in FIGS. 10A, 10B, and 11C. The mounting plate 72 and heating unit 62 can be locked in position by at least one latch 82 configured to engage the first and second rails 74 and 76. For instance, the at least one latch 82 can be biased to engage a plurality of notches on the first and second rails 74 and 76. Alternatively, the at least one latch 82 can lock the position of the mounting plate 72 by manually engaging the latch. For instance, the at least one latch 82 can engage the rail with friction, a cam, or a pin connection.

To assist the user moving the mounting plate 72 between the top and bottom position, the vertical rail system 70 can include a handle 84 connected to the mounting plate 72. The handle 84 can be placed on either or both sides of the mounting plate 72. Additionally, the vertical rail system 70 can include a lift support mechanism 86 that counters the weight of the mounting plate 72 and the heating unit 62 such that the user can move the heating unit 62 with minimal effort. A lift support cover 88 can cover and prevent access to the lift support mechanism 86, to prevent a user from accessing any moving parts that could present a pinch or injury hazard. The lift support mechanism 86 could be a spring or series of springs that counteract the weight of the mounting plate 72 and the heating unit 62. Alternatively, the lift support mechanism 86 could be a counterweighted pulley system. In another embodiment, the lift support mechanism 86 could include a manual hand crank system. A rotating handle could be attached to a gear that interfaces with gear teeth on at least one of the first and second rails. A user could raise the heating unit 62 by rotating the handle in one direction and lower the heating unit 62 by rotating the handle in the opposite direction. In yet another embodiment, the lift support mechanism 86 be hydraulic, gas operated, or electric. For instance, the lift support mechanism could be an electric linear actuator that could be controlled with the controller 60. For instance, the controller 60 could be programed to automatically move the heating unit 62 to set locations or any position between the top and bottom positions allowed by the first and second rails 74 and 76. The vertical rail system 70 could be made from a corrosion resistant metal, like stainless steel or galvanized steel/aluminum. While the user would be instructed not to use the vertical rail system 70 when the heating unit 62 is active, parts of the vertical rails system 70 that the user engages with, like the handle 84 and at least one latch 82, can be covered in a material with a low heat conductivity like wood or silicon for comfort and safety.

The vertical rail system 70 allows the user to customize the heat distribution within the chamber 10 because heat rises. The heat produced by the heating unit 62 will generally move from the top of the heating unit to the top of the chamber and eventually be exhausted through the ventilation outlet holes 54. When the heating unit 62 is at the top position allowed by the vertical rail system 70, less of the chamber 10, approximately the top half of the chamber 10, will receive the intense heat created by the heating unit 62. In this position, the top half of the chamber 10 would be an intensely heated zone and the bottom half of the chamber would be a mildly heated zone. Alternatively, when the heating unit 62 is at the bottom position allowed by the vertical rail system 70, more of the chamber (almost all of the chamber) will receive the intense heat created by the heating unit 62. In this position, most of the chamber 10 would be the intensely heated zone. The heating unit 62 can be placed at any position between the top and bottom positions of the vertical rail system 70 to customize the distribution of heat in the chamber 10.

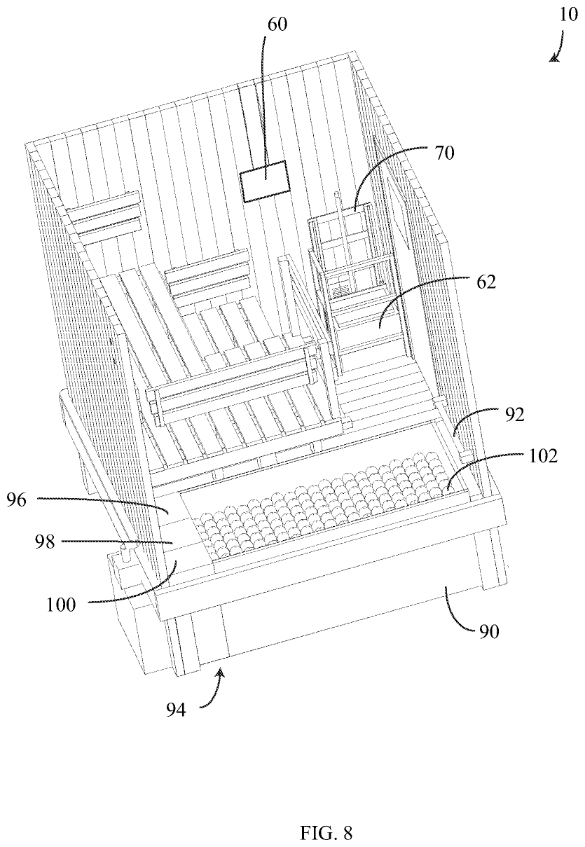

Returning to FIGS. 6-10B, the plunge pool system 14 includes a pool 90 that has a top at substantially the same level as at the floor 28 of the chamber 10. A user can step down into the pool 90 to participate in cold temperature therapy without leaving the chamber 10. The pool 90 can include a step or ledge (not illustrated) to make it easier to enter and exit the pool 90. Assist handles 92 can be placed around the pool to provide a gripping handle to make it easier to enter and exit the pool 90. For instance, assist handles 92 can be installed on the wall near the pool and the first and second benches 42 and 44 near the pool, as illustrated in FIGS. 6 and 8. The pool 90 is sized to allow a single user to sufficiently submerge their entire body up to their neck while sitting down. The pool 90 can be rectangular as illustrated. It will be appreciated that the pool can be other shapes and sizes depending on the shape and size of the chamber 10. For instance, if the chamber is larger to accommodate more people, the pool 90 can be larger to allow more users to simultaneously submerge themselves in the pool 90. The pool 90 can also be circular, triangular, polygonal, or any other suitable shape. The pool 90 can be made from plastic, fiberglass, corrosion resistant metals, a composite material, or some other suitable material.

To maintain the water in the pool 90, the plunge pool system 14 includes a control unit 94. The control unit 94 includes a chiller unit 96 to control the temperature of the water, a filtration unit 98 to keep the water clean, and a circulation unit 100 to move the water through the chiller unit 96, the filtration unit 98, and back into the pool 90. The chiller unit 96 can maintain the temperature of the water between 50 and 60 degrees Fahrenheit, based on the user's input into the controller 60, to provide the benefits of cold temperature therapy. Alternatively, the chiller unit 96 can maintain the temperature of the water between 32 and 65 degrees Fahrenheit, based on the user's input into the controller 60. The temperature of the water in the pool 90 can also be manually maintained by the user, for instance by adding ice to the water. The filtration unit 98 can be any suitable water filtration system that can capture impurities, contaminants, and debris in the water. For instance, the filtration unit 98 can be a common filtration system used in pools or hot tubs. Similarly, the circulation unit 100 can be a common pump system used to circulate water in pools or hot tubs.

The chiller unit 96, filtration unit 98, the circulation unit 100, and other sensors from the plunge pool system 14 are all configured to be controlled with the controller 60 in the chamber. Temperature sensors can be configured to communicate the status of the water, including the water temperature, to the controller 60. The temperature sensors and other sensors can also monitor the plunge pool system 14 for errors, status, and safety issues. For instance, the controller 60 can indicate when the filtration unit 98 needs to be cleaned or serviced or when a filter needs to be replaced based on elapsed time or feedback from a sensor. A user can use the controller 60 to select their desired water temperature and the chiller unit 96 can subsequently be activated to change the water temperature. The controller 60 can activate the circulation unit 100 based on the input from the user. For instance, a user could shut off the circulation unit while the user is using the plunge pool 90 for cold therapy.

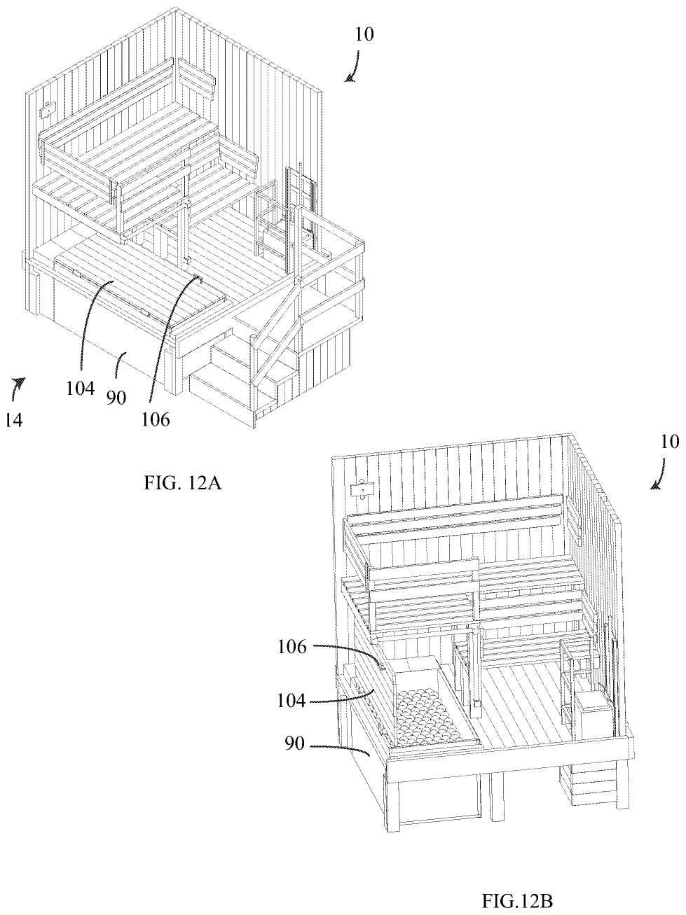

To maintain the temperature and prevent evaporation of the water in the pool 90 in the chamber 10, various types of insulation may be used. For instance, the walls of the pool 90 can be filled with an insulation material to insulate the pool 90 from the environment outside of the chamber 10 and below the platform. Additionally, a plurality of insulation balls 102 can float on and cover the surface of the water in the pool 90. The insulation balls 102 may be made of polyethylene, or other suitable polymer. The insulation balls 102 create a dynamic barrier between the water surface and the chamber 10 that adapts to a user as they enter and move around in the pool. The insulation balls 102 float on the surface of the water and mitigate evaporation of the water. The pool 90 can also include a cover 104 that covers the pool 90 when it is not being used. The cover 104 can be a hinged trap door that has a closed position, shown in FIG. 12A, and an open position, shown in FIG. 12B. The cover 104 can be opened and pivoted toward the wall to the open position to allow access to the pool 90. To move the cover 104 to an open position, a user can pull upwards on a handle 106 on the top surface of the cover 104. The cover 104 can include a cover lift assist system to counter and hold the weight of the cover and to minimize the effort required to open the cover 104. For instance, the cover lift assist system could be a gas strut installed between the pool 90 and the cover 104, a weighted pulley system, a spring or series of springs configured to assist pivoting the cover 104 open, a mechanical or eletromechanical actuator configured to pivot the cover 104 open, or any other suitable lifting system. The cover 104 can be substantially thick enough to include the same insulation that is in the walls of the pool 90. A top surface of the cover 104 can include material that matches the floor 28 of the chamber. A compressible seal can extend around the perimeter of the cover 104 to prevent water from evaporating out of the pool 90 when the cover 104 is in the closed position.

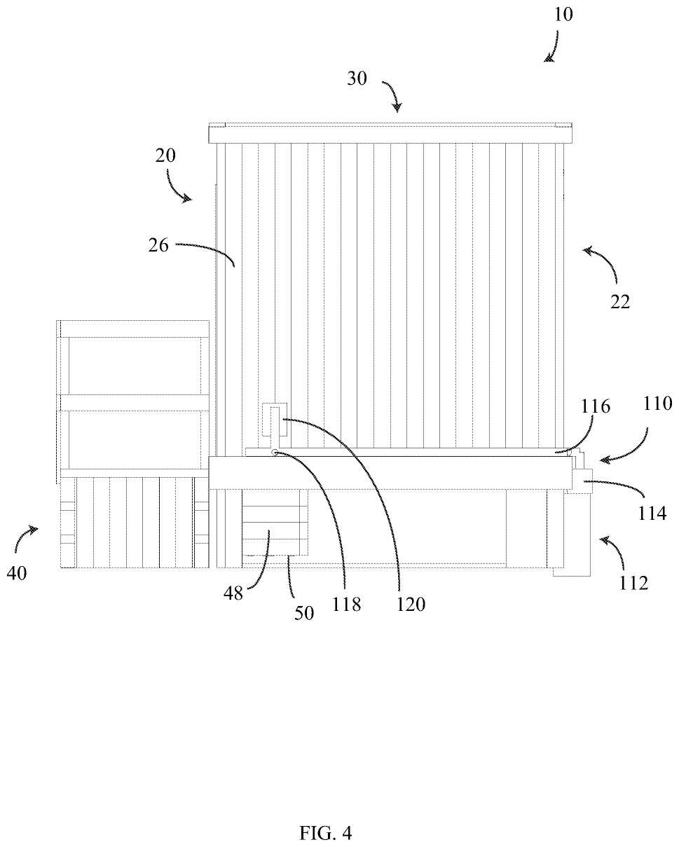

To improve the efficiency of the chamber 10, a heat recycling system 110 can be integrated with the plunge pool system 14 to capture waste heat produced by the plunge pool system 14. The waste heat can be circulated back into the chamber 10 to help maintain the temperature inside the chamber 10. While operating, the chiller unit 96 and the circulation unit 100 may produce excess heat that heats the air around the chiller unit 96 and the circulation unit 100. Rather than exhausting the heated air, an intake cover 112 can cover the exhaust of the chiller unit 96 and the circulation unit 100 to capture the heated air. An intake fan 114 located in or adjacent to the intake cover 112 can pull the heated air out of the intake cover 112 and force it into an insulated air duct 116 that extends around or under the chamber 10. The intake fan 114 can be operating anytime the chiller unit 96 is operating. As illustrated in FIGS. 3, 4, and 7, the air duct 116 extends around chamber 10 along the back wall 22 and the second side wall 26. At the other end of the air duct 116, an air valve 118 can direct the heated air back into the chamber 10 through a heat-recycling vent 120 in a wall of the chamber when the air valve 118 is in an open position or exhaust the heated air into the external environment when the air valve 118 is in a closed position. Alternatively, the air valve 118 can be located near the intake fan 114. The air valve 118 can be an electrically operated valve that is configured to be controlled by the controller 60. The air valve 118 can be programmed to open the valve and direct air into the chamber based on temperature sensor readings or if the heating unit 62 is currently active. A user can also choose to manually open or close the air valve 118 with the controller 60. Alternatively, the air valve 118 can be a simple manual valve in the chamber 10 that the user can open or close. The heat-recycling vent 120 extends through one of the walls of the chamber 10. As illustrated in FIGS. 4, 8, and 9A, the heat-recycling vent 120 can be located in the second side wall 26 proximate the heating unit 62 and the ventilation inlet holes 52. It will be appreciated that the position of the elements of the heat recycling system 110, like the intake fan 114, the air duct 116, the air valve 118, and the heat-recycling vent 120 can be optimized through sound engineering judgement.

As described throughout the application, a user can control the functions of the heating system 12 and the plunge pool system 14 with the controller 60. In one embodiment, the controller 60 may be a simple control circuit. In other embodiments, the controller 60 may be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The controller 60 may be a microprocessor, but in the alternative, the controller 60 may be any processor, controller, microcontroller, or state machine. The controller 60 may also be implemented as a combination of computing devices, for example a combination of a DSP and a microprocessor, a plurality of microprocessors, multi-core processors, one or more microprocessors in conjunction with a DSP core, or any other such configuration.

In one embodiment, the controller 60 can be a control panel, such as a touch screen control panel having a graphic user interface that allows the user to control the functions of the heating system 12 and the plunge pool system 14 to achieve their desired temperature contrast therapy regiment. The touchscreen control panel can include a variety of menus and submenus to change the temperatures and settings in the chamber 10 and the pool 90 as previously discussed. The control panel can be configured to communicate with various temperature sensors and other sensors to monitor the chamber 10, the heating system 12, the plunge pool system 14, and the various subsystems previously described. The control panel can provide information related to the status, operation, and safety in the chamber 10, like operation errors and safety errors or issues. It will be appreciated that the controller 60 can control the heating system 12 and plunge pool system 14 individually. In other words, a user can use either the heating system 12 or the plunge pool system 14 individually just for hot therapy or cold therapy respectively.

The controller can generally display information like a clock, a therapy session timer, and the current temperature in the chamber 10 or the pool 90. The controller 60 can be configured to integrate and communicate wirelessly with a user's personal device or wellness device, such as a mobile phone, smart watch, or activity tracker. The user's personal device or wellness device can include software that interfaces with the controller 60 and controls the temperature and settings within the chamber 10. The user's wellness device could include sensors that provide physiological and health monitoring information to the controller 60 to further customize therapy session based on physiological feedback from the user. Therefore, the controller 60 can be configured to allow the temperature contrast therapy experience to be customized to individual users. As an example, a user could change the temperature of the plunge pool system 14 with their personal device. Further, the controller 60 could include smart thermostat features, such as automatically adjusting the temperature and other settings in the chamber based on the specific user in the chamber 10. The controller 60 could also be configured to operate based on voice commands from a user. The controller 60 can include machine-learning algorithms that analyze a user's preferences and physiological responses to optimize and personalize therapy sessions over time. Alternatively, the controller 60 could include pre-programmed therapy sessions that automatically time heat and cold therapy intervals and direct a user to change between therapy types.

The chamber 10 has primarily been described as a compact standalone unit. In this configuration, the chamber 10 can be constructed outdoors in a residential, spa, hotel, or other suitable setting to provide temperature contrast therapy. Alternatively, the chamber 10 has a variety of other potential configurations, such as being constructed indoors where the pool is an in ground pool in a residential, spa, hotel, or other suitable setting. As previously mentioned, the chamber 10 is scalable in size to be able to accommodate multiple users at one time. The chamber 10 can also be modular allowing customizable placement of the benches, heaters, doors, etc. based on the location, size, and shape of the chamber 10. In an alternative embodiment, the chamber 10 can be configured to be portable. For instance, the chamber 10 can be design to be easily assembled and disassembled for temporary installations of the chamber 10.

The aforementioned systems, components, (e.g., heating system, plunge pool system, actuators, controllers, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A temperature therapy chamber comprising:
a housing with an interior for accommodating a user;
a heating system configured to increase the temperature within the housing to create a heated area; and
a plunge pool system comprising:
a pool having an opening accessible from within the interior of the housing and configured to hold water and accommodate the user; and
a chiller configured to decrease the temperature of the water in the pool,
wherein the user can move between the heated area in the housing and the pool without leaving the interior of the housing.

2. The temperature therapy chamber of claim 1, wherein the opening of the pool is at substantially the same level as a floor of the housing.

3. The temperature therapy chamber of claim 1, wherein the plunge pool system further comprises a filtration system and a water circulation system.

4. The temperature therapy chamber of claim 1, wherein the heating system includes a heating element mounted to a wall of the interior of the housing.

5. The temperature therapy chamber of claim 4, further comprising a vertical rail system mounted to a wall of the interior of the housing, the vertical rail system comprising:
at least one rail mounted to the wall of the housing and extending up the wall of the housing;
a mounting plate with a first side slidably coupled to the at least one rail and a second side opposite the first side that is configured to removably support the heating system; and
a locking mechanism having a locked position and an unlocked position,
wherein mounting plate can slide up and down the at least one rail to change the height of the heating element within the interior of the housing and the locking mechanism locks the position of the mounting plate relative to the at least one rail in the locked position.

6. The temperature therapy chamber of claim 5, further comprising a heating element housing extending downwardly from the floor of the housing below the heating element and configured to receive the heating element when the heating element and mounting plate are lowered into a low position on the at least one rail.

7. The temperature therapy chamber of claim 5, wherein the vertical rail system further comprises a lift assist mechanism configured to counteract the weight of the heating element and the mounting plate.

8. The temperature therapy chamber of claim 5, wherein the locking mechanism is one of a latch, a spring-biased latch, a pin connection, a cam, or mechanical fastener that is configured to engage the at least one rail.

9. The temperature therapy chamber of claim 1, further comprising a heat recovery system comprising:
a heat recovery cover configured to capture hot air exhausted by the chiller;
an insulated air duct connected to the heat recovery cover at a first end and a vent in a wall of the housing at a second end; and
a fan configured to pull air from the cover into the first end of the air duct and blow it toward the second end of the air duct.

10. The temperature therapy chamber of claim 9, wherein the heat recovery system further comprises an air valve having an open position where the hot air is blown into the interior of the housing and a closed position where the hot air is exhausted outside of the housing.

11. The temperature therapy chamber of claim 1, further comprising an elevated platform configured to support the housing and provide space under the housing for the plunge pool system.

12. The temperature therapy chamber of claim 1, wherein the plunge pool system further comprises an insulated cover configured to cover the opening of the pool when it is not in use to prevent evaporation of the water in the pool.

13. The temperature therapy chamber of claim 1, wherein the plunge pool system further comprises a plurality of insulation balls that cover a surface of the water and prevent evaporation of the water in the pool when the user is in the pool.

14. The temperature chamber of claim 1, wherein the housing is made of one of red cedar, white cedar, spruce, redwood, hemlock, poplar, basswood, aspen, eucalyptus, pine, or fir wood.

15. The temperature chamber of claim 1, further comprising a control panel configured to change the temperature of the interior of chamber by controlling the heating system and the temperature of the water in the pool by controlling the chiller of the plunge pool system.

16. A temperature therapy chamber comprising:
a housing with an interior for accommodating a user;
a heating system having a heating element configured to increase the temperature within the housing to create a heated area; and
a vertical rail system comprising:
at least one rail mounted to the wall of the chamber and extending up the wall of the housing;
a mounting plate with a first side slidably coupled to the at least one rail and a second side opposite the first side that is configured to removably support the heating element; and
a locking mechanism having a locked position and an unlocked position,
wherein the mounting plate can slide up and down the at least one rail to change the height of the heating element within the interior of the housing and the locking mechanism locks the position of the mounting plate relative to the at least one rail in the locked position.

17. The temperature therapy chamber of claim 16, further comprising a heating element housing extending downwardly from the floor of the housing below the heating element and configured to receive the heating element when the heating element and mounting plate are lowered into a low position on the at least one rail.

18. The temperature therapy chamber of claim 16, wherein the vertical rail system further comprises a lift assist mechanism configured to counteract the weight of the heating element and the mounting plate.

19. The temperature therapy chamber of claim 16, wherein the locking mechanism is one of a latch, a spring-biased latch, a pin connection, a cam, or mechanical fastener.

20. A temperature therapy chamber comprising:
a housing with an interior for accommodating a user;
a heating system having a heating element configured to increase the temperature within the housing to create a heated area;
a plunge pool system comprising:
a pool having an opening accessible from within the interior of the housing and configured to hold water and accommodate the user; and
a chiller configured to decrease the temperature of the water in the pool;
a vertical rail system comprising:
at least one rail mounted to the wall of the housing and extending up the wall of the housing;
a locking mechanism having a locked position and an unlocked position; and
a mounting plate with a first side slidably coupled to the at least one rail and a second side opposite the first side that is configured to removably support the heating element, wherein the mounting plate can slide up and down the at least one rail to change the height of the heating element within the interior of the housing and the locking mechanism locks the position of the mounting plate relative to the at least one rail in the locked position; and
a heat recovery system comprising:
a heat recovery cover configured to capture hot air exhausted by the chiller;
an insulated air duct connected to the heat recovery cover at a first end and a vent in a wall of the housing at a second end; and
a fan configured to pull air from the heat recovery cover into the first end of the air duct and blow it toward the second end of the air duct and into the interior of the housing through the vent,
wherein the user can move between the heated area in the housing and the pool without leaving the interior of the housing.
